(19) United States
(12) Patent Application Publication
(10) Pub. No.: US 2006/0128418 A1
(43) Pub. Date: Jun. 15, 2006

(54) Phone functions triggered by broadcast data

(75) Inventors: Hans-Christoph Quelle, Dusseldorf (DE); Achim Reidelsturz, Wulfrath (DE); Jukka Nihtila, Espoo (FI); Heikki Huomo, Oulu (FI)

Correspondence Address: BANNER & WITCOFF, 1001 G STREET N W, SUITE 1100, WASHINGTON, DC, 20001, US

(73) Assignee: Nokia Corporation, Espoo (FI)

(21) Appl. No.: 11/012,076

(22) Filed: Dec. 14, 2004

(51) Int. Cl. H04M 1/00

(52) U.S. Cl. 455/550.1

(57) ABSTRACT

A method for delivering program related content information to users over broadcast media. A user initiates a request to contact a program such as a shopping television program by inputting an indication that the user would like to contact the program. The mobile terminal utilizes contact information embedded in a broadcast signal to initiate a connection between the mobile device and a telephone or other device associated with the program. The contact information received in the broadcast signal may be stored in a phone book application of the mobile terminal.

### FIELD OF THE INVENTION

The invention relates generally to communications networks. More specifically, the invention provides a method for providing contact information to mobile terminals over broadcast media.

### BACKGROUND OF THE INVENTION

A variety of mobile computing and receiver devices exist, such as personal digital assistants (PDAs), mobile phones, digital players, and mobile terminals. These mobile computing devices perform various functions specific to the device, and are often capable of communicating with other devices. The mobile computing devices may also be capable of receiving broadcasting services and multi-media content distributed by such broadcasting services.

Digital broadcast technologies using standards such as DVB-T (Digital Video Broadcast-Terrestrial) are rapidly expanding in various countries around the world. Other standards such as DVB-H (Digital Video Broadcast-Handheld) are taking the DVB-T standard further by enabling digital content providers to address all types of terminals ranging from low-end to high-end set top boxes, integrated digital TV sets and multimedia PCs. In addition, the standards provide for the reception of digital broadcasting with handheld devices such as mobile data terminals. The DVB transmission technology (also known as IP datacasting) may also be combined with Internet Protocol (IP). The combination makes it possible to transfer digital content as IP packets. IP datacasting offers the advantage that all existing IP-based digital content such as video streams, web pages, music files, or game software may be distributed over a mobile broadcast. IP datacasting for mobile devices, as compared to traditional broadcasting, creates a variety of advantages over traditional broadcasting systems such as the transmission of additional services over the same channel.

Additionally, mobile terminal devices are also capable of receiving FM radio transmissions. For instance, a portable device may receive data streams of related information through in-band transmission such as RDS (Radio Data System) and/or DARC (Radio Data Channel-ETSI ETS 300751) and/or IBOC for analog FM radio.

Although these mobile terminal devices may receive various sources of data, these devices do not include means for providing program related contact information to the mobile terminals over broadcast media. For example, call-in radio/television talk shows or TV shopping programs often provide a telephone number or email address through which listeners or viewers can contact the show (e.g., to talk to the show's host or purchase merchandise while the show is on the air). These shows typically provide the call-in telephone number by announcing it over the air. If an audience member does not hear the telephone number, e.g., because the audience member tuned into the show already in progress, then the audience member cannot call into the show. In addition, telephone numbers are often spoken very fast, leading to the possibility that a listener may not be able to write down the number, especially while driving a car or when the listener's eyes and/or hands are busy.

Thus, there exists a need in the art for a method and system that enables audience members or viewers to call into a program or show without being required to receive and/or remember contact information such as telephone numbers. The contact information may be broadcasted via the broadcast media and presented to a user of the mobile terminal. The contact information may be stored in the mobile terminal devices or in an application running on the mobile device such as a contact application (phone book).

### BRIEF SUMMARY OF THE INVENTION

As more sophisticated mobile devices are developed, the same mobile device can be used for mobile telephony as is used for receiving radio and/or television broadcasts or datacast services in general. For example, 3G cellular devices may receive radio as well as perform traditional mobile telephony operations. The invention provides a method for delivering program related contact information over broadcast media to mobile terminal devices and directly links to embedded phone functions.

Contact information in the form of WTAI (Wireless Telephony Application Interface) information may be embedded in the broadcasted digital data. The contact information may be delivered using an RDS, DARC, DRM or DAB or IBOC based object transport mechanism like MOT (Multimedia Object Transport) protocol and/or using IPDC technology. An application in the mobile terminal device may extract the contact information from the broadcast media, present it to the user for verification (maybe as a new Tab in the Protocol Application) and immediate action, or to store it directly in a phonebook application of the mobile terminal for later usage. Once the user has authorized certain actions, those actions can also be done automatically.

In other aspects of the invention, computer-readable instructions for implementing the disclosed methods are stored on computer-readable media. Other features and advantages of the invention will become apparent with reference to the following detailed description and figures.

### BRIEF DESCRIPTION OF THE DRAWINGS

FIG. 1 illustrates a block diagram of a wireless communication system in which various aspects of the present invention may be implemented.

FIG. 2 illustrates a block diagram of a mobile terminal in accordance with an aspect of the present invention.

FIG. 3 illustrates a block diagram of a mobile terminal user interacting with a television or radio shopping program in accordance with an aspect of the invention.

FIG. 4 illustrates a method of establishing a communication between a mobile terminal and a device associated with a broadcast program in accordance with an aspect of the invention.

### DETAILED DESCRIPTION OF THE INVENTION

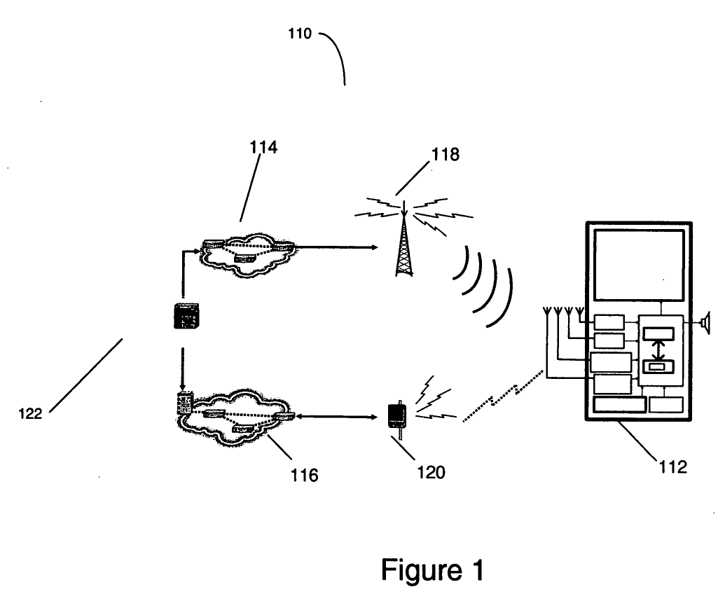

FIG. 1 illustrates an example of a wireless communication system 110 in which the systems and methods of the present invention may be advantageously employed. One or more network-enabled mobile devices 112, such as a personal digital assistant (PDA), cellular telephone, mobile terminal, personal video recorder, portable television, personal computer, digital camera, digital camcorder, portable audio device, portable radio, or combinations thereof, are in communication with a service source 122 through a broadcast network 114 and/or cellular network 116. The mobile terminal/device 112 may comprise a digital broadcast receiver device. The service source 122 may be connected to several service providers that may provide their actual program content or information or description of their services and programs to the service source that further provides the content or information to the mobile device 112. The several service providers may include but are not limited to one or more television and/or digital television service providers, analog and/or digital AM/FM radio service providers, SMS/MMS push service providers, Internet content or access providers.

The broadcast network 114 may include a radio transmission of IP datacasting over DVB and/or DVB-H. The broadcast network 114 may broadcast a service such as a digital or analog television signal and supplemental content related to the service via transmitter 118. The broadcast network may also include a radio, television or IP datacasting broadcasting network. The broadcast network 114 may also transmit supplemental content which may include a television signal, audio and/or video streams, data streams, video files, audio files, software files, and/or video games. In the case of transmitting IP datacasting services, the service source 122 may communicate actual program content to user device 112 through the broadcast network 114 and additional information such as user right and access information for the actual program content through the cellular network 116.

The mobile device 112 may also contact the service source 122 through the cellular network 116. The cellular network 116 may comprise a wireless network and a base transceiver station transmitter 120. The cellular network may include a second/third-generation (2G/3G) cellular data communications network, a Global System for Mobile communications network (GSM), or other wireless communication network such as a WLAN network.

In one aspect of the invention, mobile device 112 may comprise a wireless interface configured to send and/or receive digital wireless communications within cellular network 116. The information received by mobile device 112 through the cellular network 116 or broadcast network 114 may include user selection, applications, services, electronic images, audio clips, video clips, and/or WTAI (Wireless Telephony Application Interface) messages. As part of cellular network 116, one or more base stations (not shown) may support digital communications with receiver device 112 while the receiver device is located within the administrative domain of cellular network 116.

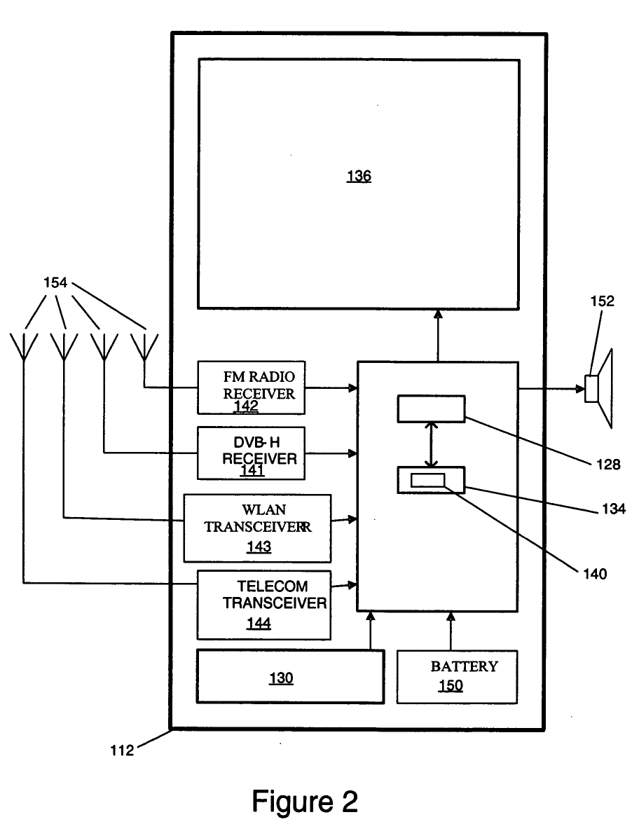

As shown in FIG. 2, mobile device 112 may include processor 128 connected to user interface 130, memory 134 and/or other storage, and display 136. Mobile device 112 may also include battery 150, speaker 152 and antennas 154. User interface 130 may further include a keypad, touch screen, voice interface, one or more arrow keys, joy-stick, data glove, mouse, roller ball, touch screen, voice interface, or the like.

Computer executable instructions and data used by processor 128 and other components within mobile device 112 may be stored in a computer readable memory 134. The memory may be implemented with any combination of read only memory modules or random access memory modules, optionally including both volatile and nonvolatile memory. Software 140 may be stored within memory 134 and/or storage to provide instructions to processor 128 for enabling mobile device 112 to perform various functions. Alternatively, some or all of mobile device 112 computer executable instructions may be embodied in hardware or firmware (not shown).

Mobile device 112 may be configured to receive, decode and process transmissions based on the Digital Video Broadcast (DVB) standard, such as DVB-H or DVB-MHP, through a specific DVB receiver 141. Additionally, receiver device 112 may also be configured to receive, decode and process transmissions through FM/AM Radio receiver 142, WLAN transceiver 143, and telecommunications transceiver 144. In one aspect of the invention, mobile device 112 may receive messages via radio data system (RDS).

In an example of the DVB standard, one DVB 10 Mbit/s transmission may have 200, 50 kbit/s audio program channels or 50, 200 kbit/s video (TV) program channels. The mobile device 112 may be configured to receive, decode, and process transmission based on the Digital Video Broadcast-Handheld (DVB-H) standard or other DVB standards, such as DVB-MHP, DVB-Satellite (DVB-S), DVB-Terrestrial (DVB-T) or DVB-Cable (DVB-C). Similarly, other digital transmission formats may alternatively be used to deliver content and information of availability of supplemental services, such as ATSC (Advanced Television Systems Committee), NTSC (National Television System Committee), ISDB-T (Integrated Services Digital Broadcasting-Terrestrial), DAB (Digital Audio Broadcasting), DMB (Digital Multimedia Broadcasting) or DIRECTV. Additionally, the digital transmission may be time sliced, such as in DVB-H technology. In this case the mobile device 112 may have one or more buffer memories for storing the decoded time sliced transmission before presentation.

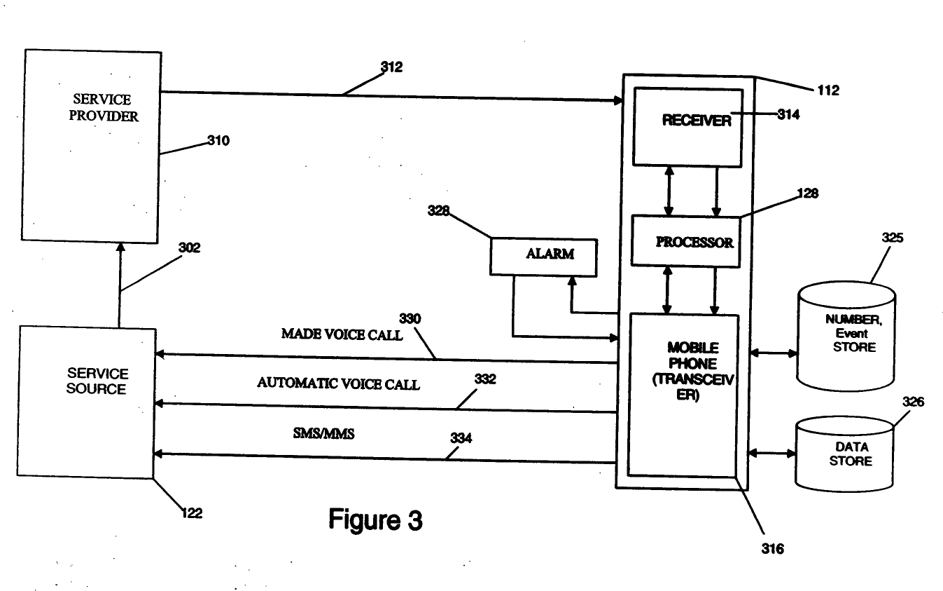

FIG. 3 illustrates an aspect of the invention using a block diagram for illustration of a mobile terminal user interacting with a television or radio shopping program. In this exemplary scenario, a user of a mobile terminal 112 receives a broadcast soliciting the listener or viewer to call into a show to purchase products. As shown in FIG. 3, the service source 122 may provide access information which may include a telephone number, an email address, an IP address, a URL, an SMS message address, or the like for contacting the provider. A listener or viewer receiving the content of the program may decide to contact the program 330 using their mobile terminal 112 in order to purchase the advertised product. The access or contact information may be transmitted to a service provider or broadcaster 310 in the form of an IP stream 302. The IP stream 302 may include the contact information in WTAI format. The contact information may take the form of a phone number. Service provider 310 may broadcast 312 the shopping program along with contact information. The broadcast may be based on the Digital Video Broadcast (DVB) standard, such as DVB-H or DVB-MHP or a FM/AM transmission. In another aspect of the invention, the broadcast may contain an RDS or DARC or IBOC message. Moreover, the transmission may be based on a RTP transmission. For an RTP transmission, the WTAI data may be transmitted as own RTP-stream corresponding to audio, video and subtitling.

WTAI data may also be sent using WAP Push protocol, e.g. by using SMS. For WAP Push two protocols may be defined: HTTP and WSP. Additional information or data may also be provided in XML format and transmitted along with the contact information. The data may be embedded in a DVB signal by using a different IP source address than for the other IP streams (video, audio, etc.). The message format for the associated data may comprise XML, XHTML or the like.

A mobile terminal 112 may comprise a broadband digital receiver 314 (e.g. a DVB-H receiver) and/or a mobile phone transceiver 316. Additionally, the mobile terminal 112 may also comprise an analog receiver (e.g. a FM receiver in FIG. 2) and/or a narrowband digital receiver.

The WTAI message embedded in the broadcasted signal may be extracted by processor 128 and the contact information stored in data storage 325 or 326. The extraction of the WTAI message data may be performed in one embodiment of the invention using a WTA (Wireless Telephony Application) user agent residing in the mobile device. The extracted information may influence the message shown on the display of the device. The displayed message may inform the user that a new message has been received, and/or that the user may select to store the received message or parts thereof to the memory of the device, e.g. to the phonebook. The contact information may be displayed in one embodiment of the invention directly in a portion of the screen or in a predefined location. The predefined location may be a field that is used for inputting a phone number for establishing a call, wherein the user may set up a call to the displayed number easily, e.g. by a single push of a button. The contact information may take the form of telephone numbers which may be stored in a phone book application. Additional data which may be included in the broadcasted signal may include suggested or allowed calling times for using the contact information. The suggested or allowed calling times may be used for setting an alarm 328 or making a call during the suggested/allowed time.

In another aspect of the invention, the contact information such as the phone numbers and/or calling times may be defined regionally so that they are transmitted only in the selected regions at selected times. The regional selection can be based on information in SI/PSI tables (e.g. cell_id) or on mobile phone cell_id. In one embodiment, the mobile terminal 112 may make the selection as to when to show the number/message based on the cell_id (phone or DVB). In another embodiment, the transmission coverage (region or time) of the phone number(s) and/or other data may be decided by service provider 310.

In another aspect of the invention, the system may be used in simple voting applications, wherein the possible (allowed) alternatives may be associated with different phone numbers. In one embodiment the user may send a SMS 334 to the selected number. The user may input or select the message content of the SMS/MMS. The selection may be made from data stored in the mobile terminal 112 or from the associated data that was delivered together with the phone number. Further in one embodiment each of received telephone numbers may be associated with different message data. If the possible alternatives are not associated with different phone numbers, the SMS message may comprise the selected alternative inputted by the user according to instructions. In another aspect of the invention the user may select to establish an automatic voice call 332, wherein the call may or may not include a voice message. The voice message in the automatic voice call may have been received as part of the additional data or it may be retrieved from the data store 326.

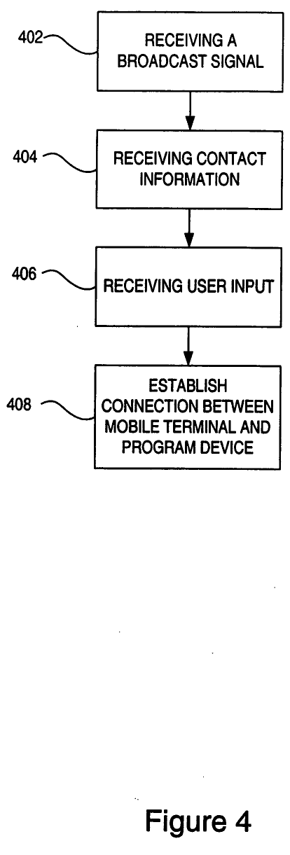

FIG. 4 illustrates a method of establishing a communication between a mobile terminal 112 and a device associated with a broadcast program in accordance with an aspect of the invention. In FIG. 4, at step 402 a mobile terminal 112 receives a broadcast signal. The broadcast signal may contain a television or radio program. In step 404, the mobile terminal 112 receives contact information. The contact information may be extracted by the mobile terminal 112 from the broadcast signal. The contact information may be automatically stored in a telephone book application for later retrieval. The contact information stored in the telephone book application may be tagged as anew contact. A user of the telephone book application may browse or search the contacts stored in the telephone book application and choose to manually store the contact information. If the contact information is not saved by the user or used within a determined period of time (e.g. 2 days—parameter which the end user should set) the contact information may be automatically erased from the telephone book application.

The contact information may be used to establish a voice connection with a device associated with the broadcasted program. In step 406, the mobile terminal 112 receives input from a user to establish a connection with the device associated with the broadcasted program. In step 408, a connection is established between the mobile terminal 112 and the program device in order for a user to communicate with the show or program.

One of skill in the art will appreciate that many variations are possible that remain within the scope of the present invention. While the above examples refer to call-in radio and TV programs, the principles taught herein may also be used to receive additional information regarding other types of broadcasts, including advertisements and game shows. For example, when an advertisement is being broadcast that a user wants to learn more about, the user can use the contact information to connect the mobile terminal 112 to a third party associated with the advertisement (e.g., a sales representative). It should be apparent to one of skill in the art that, while the above examples are directed to mobile devices, the inventive methods and systems may also be used with non-mobile devices that receive broadcasts and perform telephony operations. In addition, the principles taught herein may also be used with non-wireless systems, such as Internet radio, TV, telephony or any other future broadcast systems.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. A mobile terminal for receiving broadcast media, the mobile terminal comprising:
a processor;
a display; and
memory storing computer readable instructions that, when executed by the processor, perform the steps of:
receiving broadcast media;
extracting contact information and other related and non-related information from the broadcast media;
receiving user input to initiate an action; and
performing the action with a device associated with the broadcast media through use of the received contact information or the other related and non-related information.

2. The mobile terminal of claim 1, further comprising the step of storing the contact information for future use in the mobile terminal's phone book application.

3. The mobile terminal of claim 1, further comprising the step of verifying user authorization before establishment of the communication connection with the device associate with the broadcast media.

4. The mobile terminal of claim 1, wherein the contact information comprises data in WTAI format.

5. The mobile terminal of claim 1, further comprising the step of displaying an indicator of the availability of contact information for the broadcast media on the display of the mobile terminal.

6. The mobile terminal of claim 1, further comprising the step of displaying the contact information for the broadcast media on the display of the mobile terminal.

7. The mobile terminal of claim 1, wherein the broadcast media comprises a broadcast program.

8. A computer readable medium having computer readable instructions for performing the steps of:
receiving a broadcast program;
extracting contact information for the broadcast program;
receiving user input to initiate a connection with a device associated with the broadcast program;
transmitting a request to the device associated with the broadcast program using the broadcast contact information in order to initiate the connection; and
if the request is accepted, establishing the connection with the device associated with the broadcast program.

9. The computer readable medium of claim 8, further comprising the step of storing the contact information for future use in the mobile terminal's phone book application.

10. The computer readable medium of claim 8, wherein the step of verifying user authorization before establishment of the communication connection with the device associate with the broadcast media.

11. The computer readable medium of claim 8, wherein the contact information comprises data in WTAI format.

12. In a mobile terminal, a method of establishing a voice connection between a user of the mobile terminal and a device associated with a broadcast program, the method comprising the steps of:
receiving a broadcast signal at the mobile terminal, the broadcast signal comprising contact information for connection of the mobile terminal to the device associated with the broadcast program;
in response to a user-activated command, transmitting a request using the contact information to establish a voice connection with the device associated with the broadcast radio program; and
establishing a voice connection with the device associated with the broadcast radio program.

13. The method of claim 12, wherein the contact information comprises data in WTAI format.

14. The method of claim 12, further comprising the step of displaying an indicator of the availability of contact information for the broadcast program on a display of the mobile terminal.

15. The method of claim 12, further comprising the step of displaying the contact information for the broadcast program on the display of the mobile terminal.

16. In a portable device having a graphical user interface including a display and a user interface selection device, a method of establishing a voice connection between a user of the mobile terminal and a device associated with a broadcast program, the method comprising the steps of:
receiving a broadcast signal at the mobile terminal, the broadcast signal comprising contact information for connection of the mobile terminal to the device associated with the broadcast program;
displaying a message related to the contact information on the display of the mobile terminal during receipt of the broadcast signal; and
linking the received contact information to a phone application in the mobile terminal on a user selection.

17. The method of claim 16, wherein displaying a message related to contact information comprises displaying an indicator of the availability of contact information for the broadcast program on a display of the mobile terminal.

18. The method of claim 16, further wherein displaying a message related to contact information comprises displaying the contact information for the broadcast program on the display of the mobile terminal.
